(19) United States
(12) Patent Application Publication
(10) Pub. No.: US 2009/0186421 A1
(43) Pub. Date: Jul. 23, 2009

(54) Catalytic Biosensor

(76) Inventor: Alan Joseph Bauer, Jerusalem (IL)

Correspondence Address: Alan Joseph Bauer, 49 Ussishkin Street, Jersusalem, 94542, IL

(21) Appl. No.: 12/083,326

(22) PCT Filed: Sep. 28, 2006
(86) PCT No.: PCT/IL06/01137

§ 371 Date: Apr. 8, 2008

(30) Foreign Application Priority Data
Oct. 11, 2005 (IL) 171362

(51) Int. Cl. G01N 21/01

(52) U.S. Cl. 436/164; 422/68.1; 422/55

(57) ABSTRACT

The present invention describes a biosening device and method. Specifically, binding of target analyte perturbs the surface of a sensor strip so that gas bubbles are generated in solution. The gas bubbles may be detected for determination of analyte presence in a sample.

### BACKGROUND OF THE INVENTION

1. Field of the Invention

This invention pertains to a sensor and method for detecting or quantifying analytes. More particularly the present invention is directed to the detection of analytes by certain enhanced non-enzymatic catalytic events directly related to analyte interaction with immobilized binding agents associated with a solid element.

2. Description of the Related Art

Chemical and biological sensors are devices that can detect or quantify analytes by virtue of interactions between targeted analytes and macromolecular binding agents such as enzymes, receptors, DNA strands, heavy metal chelators, or antibodies. Such sensors have practical applications in many areas of human endeavor. For example, biological and chemical sensors have potential utility in fields as diverse as blood glucose monitoring for diabetics, detection of pathogens commonly associated with spoiled or contaminated food, genetic screening, and environmental testing.

Chemical and biological sensors are commonly categorized according to two features, namely, the type of material utilized as binding agent and the means for detecting an interaction between binding agent and targeted analyte or analytes. Major classes of biosensors include enzyme (or catalytic) biosensors, immunosensors and DNA biosensors. Chemical sensors make use of synthetic macromolecules for detection of target analytes. Some common methods of detection are based on electron transfer, generation of chromophores, or fluorophores, changes in optical or acoustical properties, or alterations in electric properties when an electrical signal is applied to the sensing system.

Enzyme (or catalytic) biosensors utilize one or more enzyme types as the macromolecular binding agents and take advantage of the complementary shape of the selected enzyme and the targeted analyte. Enzymes are proteins that perform most of the catalytic work in biological systems and are known for highly specific catalysis. The shape and reactivity of a given enzyme limit its catalytic activity to a very small number of possible substrates. Enzymes are also known for speed, working at rates as high as 10,000 conversions per second per enzyme molecule. Enzyme biosensors rely on the specific chemical changes related to the enzyme/analyte interaction as the means for determining the presence of the targeted analyte. For example, upon interaction with an analyte, an enzyme may generate electrons, a colored chromophore or a change in pH (due to release of protons) as the result of the relevant catalytic enzymatic reaction. Alternatively, upon interaction with an analyte, an enzyme may cause a change in a fluorescent or chemiluminescent signal that can be recorded by an appropriate detection system.

Immunosensors utilize antibodies as binding agents. Antibodies are protein molecules that bind with specific foreign entities, called antigens, which can be associated with disease states. Antibodies attach to antigens and either remove the antigens from a host and/or trigger an immune response. Antibodies are quite specific in their interactions and, unlike enzymes, they are capable of recognizing and selectively binding to very large bodies such as single cells. Thus, antibody-based biosensors allow for the identification of certain pathogens such as dangerous bacterial strains. As antibodies generally do not perform catalytic reactions, there is a need for special methods to record the moment of interaction between target analyte and recognition agent antibody. Changes in mass (surface plasmon resonance, acoustic sensing) are often recorded; other systems rely on fluorescent probes that give signals responsive to interaction between antibody and antigen. Alternatively, an enzyme bound to an antibody can be used to deliver the signal through the generation of color or electrons; the enzyme-linked immunosorbent assay (ELISA) is based on such a methodology.

DNA biosensors utilize the complementary nature of the nucleic acid double-strands and are designed for the detection of DNA or RNA sequences usually associated with certain bacteria, viruses or given medical conditions. A sensor generally uses single-strands from a DNA double helix as the binding agent. The nucleic acid material in a given test sample is then denatured and exposed to the binding agent. If the strands in the test sample are complementary to the strands used as binding agent, the two interact. The interaction can be monitored by various means such as a change in mass at the sensor surface or the presence of a fluorescent or radioactive signal. Alternative arrangements provide binding of the sample of interest to the sensor and subsequent treatment with labeled nucleic acid probes to allow for identification of the sequences of interest.

Chemical sensors make use of non-biological macromolecules as binding agents. The binding agents show specificity to targeted analytes by virtue of the appropriate chemical functionalities in the macromolecules themselves. Typical applications include gas monitoring or heavy metal detection; the binding of analyte may change the conductivity of the sensor surface or lead to changes in charge that can be recorded by an appropriate field-effect transistor (FET). Several synthetic macromolecules have been used successfully for the selective chelation of heavy metals such as lead.

The present invention has applicability to all of the above noted binding agent classes.

Known methods of detecting interaction of analyte and binding agent can be grouped into several general categories: chemical, optical, acoustical, electrical, and electrochemical. In the last, a voltage or current is applied to the sensor surface or an associated medium. As binding events occur on the sensor surface, there are changes in electrical properties of the system. The leaving signal is altered as function of analyte presence.

The most relevant prior art to the present invention involves sensors that are based on electrochemical means for analyte detection. There are several classes of sensors that make use of applied electrical signals for determination of analyte presence. Amperometric sensors make use of oxidation-reduction chemistries in which electrons or electrochemically active species are generated or transferred due to analyte presence. An enzyme that interacts with an analyte may produce electrons that are delivered to an appropriate electrode; alternatively, an amperometric sensor may employ two or more enzyme species, one interacting with analyte, while the other generates electrons as a function of the action of the first enzyme, an arrangement known as a coupled enzyme system. Glucose oxidase has been used frequently in amperometric biosensors for glucose quantification for diabetics. Other amperometric sensors make use of electrochemically active species whose presence alters the system applied voltage as recorded at a given sensor electrode. Not all sensing systems can be adapted for chemical electron generation or transfer, and thus many sensing needs cannot be met by amperometric methods alone. The general amperometric method makes use of an applied voltage and effects of electrochemically active species on said voltage. An example of an amperometric sensor is described in U.S. Pat. No. 5,593,852 to Heller, et al., which discloses a glucose sensor that relies on electron transfer effected by a redox enzyme and electrochemically-active enzyme cofactor species.

An additional class of electrical sensing systems includes those sensors that make use primarily of changes in an electrical response of the sensor as a function of analyte presence. Some systems pass an electric current through a given medium; if analyte is present, there is a corresponding change in an exit electrical signal, and this change implies that analyte is present. In some cases, the binding agent-analyte complex causes an altered signal, while in other systems, the bound analyte itself is the source of changed electrical response. Such sensors are distinguished from amperometric devices in that they do not necessarily require the transfer of electrons to an active electrode. Sensors based on the application of an electrical signal are not universal, in that they depend on alteration of voltage or current as a function of analyte presence; not all sensing systems can meet such a requirement.

The following U.S. patents describe sensing systems that involve electrochemical phenomena, oftentimes performed by redox enzymes and in some cases with hydrogen peroxide. In contrast to the sensors described herewith, the present invention does not make use of redox enzymes and the sensor strip does not participate directly in any electrochemical phenomena, but rather electrostatically facilitates catalytic hydrogen peroxide degradation to oxygen and water.

The following U.S. patents describe enzyme-based or active electrochemical hydrogen peroxide detection systems and thus are not related to the present system, one that works in the absence of redox enzymes and makes use of passive electrostatic catalysis of hydrogen peroxide: U.S. Pat. No. 6,946,675; U.S. Pat. No. 6,942,518; U.S. Pat. No. 6,922,578; U.S. Pat. No. 6,939,717; U.S. Pat. No. 6,916,410; U.S. Pat. No. 6,913,877; U.S. Pat. No. 6,905,733; U.S. Pat. No. 6,902,729; U.S. Pat. No. 6,897,292; U.S. Pat. No. 6,893,637; U.S. Pat. No. 6,887,701; U.S. Pat. No. 6,881,581; U.S. Pat. No. 6,881,511; U.S. Pat. No. 6,878,810; U.S. Pat. No. 6,875,845; U.S. Pat. No. 6,872,297; U.S. Pat. No. 6,869,671; U.S. Pat. No. 6,858,440; U.S. Pat. No. 6,858,403; U.S. Pat. No. 6,856,125; U.S. Pat. No. 6,846,635; U.S. Pat. No. 6,828,425; U.S. Pat. No. 6,825,047; U.S. Pat. No. 6,821,410; U.S. Pat. No. 6,816,742; U.S. Pat. No. 6,811,659; U.S. Pat. No. 6,802,957; U.S. Pat. No. 6,801,041; U.S. Pat. No. 6,797,463; U.S. Pat. No. 6,787,106; U.S. Pat. No. 6,761,816; U.S. Pat. No. 6,719,887; U.S. Pat. No. 6,714,815; U.S. Pat. No. 6,713,309; U.S. Pat. No. 6,706,232; U.S. Pat. No. 6,699,719; U.S. Pat. No. 6,689,265; U.S. Pat. No. 6,667,159; U.S. Pat. No. 6,664,111; U.S. Pat. No. 6,660,532; U.S. Pat. No. 6,660,484; U.S. Pat. No. 6,592,746; U.S. Pat. No. 6,587,705; U.S. Pat. No. 6,576,461; U.S. Pat. No. 6,653,151; U.S. Pat. No. 6,653,124; U.S. Pat. No. 6,652,720; U.S. Pat. No. 6,623,698; U.S. Pat. No. 6,618,819; U.S. Pat. No. 6,599,448; U.S. Pat. No. 6,592,745; U.S. Pat. No. 6,544,393; U.S. Pat. No. 6,542,765; U.S. Pat. No. 6,436,682; U.S. Pat. No. 6,289,286; U.S. Pat. No. 6,281,006; U.S. Pat. No. 6,261,440; U.S. Pat. No. 6,183,418; U.S. Pat. No. 6,134,461; U.S. Pat. No. 6,121,009; U.S. Pat. No. 6,100,045; U.S. Pat. No. 6,083,367; U.S. Pat. No. 6,033,866; U.S. Pat. No. 5,972,199; U.S. Pat. No. 5,965,380; U.S. Pat. No. 5,942,102; U.S. Pat. No. 5,837,446; U.S. Pat. No. 5,795,774; U.S. Pat. No. 5,792,621; U.S. Pat. No. 5,653,222; U.S. Pat. No. 5,288,613; 4,614,714.

Additionally, the following U.S. patent applications describe enzyme-based sensor systems related to hydrogen peroxide production or degradation. As they have a mandatory enzyme or electrode component, they are distinct from the present invention. 20050215872; 20050214635; 20050208542; 20050177035; 20050175658; 20050173245; 20050170448; 20050124874; 20050112742; 20050112557; 20050027179; 20050003360; 20040235182; 20040182719; 20040175811; 20040173472; 20040167383; 20040147673; 20040137547; 20040101920; 20040096991; 20040087671; 20040072763; 20040053425; 20030236448; 20030235817; 20030224471; 20030217928; 20030214304; 20030208114; 20030199745; 20030178322; 20030170881; 20030168338; 20030166291; 20030157538; 20030135100; 20030134347; 20030120180; 20030088166; 20030081463; 20030077702; 20030068666; 20030009093; 20020164822; 20020150671; 20020142411; 20020137093; 20020137027; 20020128546; 20020090738; 20020071943; 20020061549; 20020042090; 20020026111; 20020019324; 200200006634; 20010044397; 20010039250; 20010034314; 20010017269; 20010007852; 20010003045.

Additional H₂O₂-based sensors that are not in keeping with the present sensor include the following described in the literature: Zhou, H., et al. “Hemoglobin-Based Hydrogen Peroxide Biosensor Tuned by the Photovoltaic Effect of Nano Titanium Dioxide”, Anal. Chem. 77: 6102-6104 (2005); Tripathi, V. S., et al., “Amperometric Biosensor for Hydrogen Peroxide Based on Ferrocene-Bovine Serum Albumin and Multiwall Carbon Nanotube Modified Ormosil Composite,” Biosens. Bioelectron. 2005; Varma, S & Mattiasson, B., Amperometric Biosensor for the Detection of Hydrogen Peroxide Using Catalase Modified Electrodes in Polyacrylamide,” J. Biotechnol. 119: 172-180 (2005); Salimi, A., et al., Direct Electrochemistry and Electrocatalytic Activity of Catalase Incorporated onto Multiwall carbon Nanotubes-Modified Glassy Carbon Electrode,” Anal. Biochem. 344: 16-24 (2005); Fu, R., et al., Fabrication of a Hydrogen Peroxide Biosensor Based on Self-Assemble Composite Oxide Film,” Front. Biosci. 10: 284102847 (2005); Sathe, C. S., et al., “Catheter-Tip Sensor to Monitor Production of Hydrogen Peroxide in Small Biosamples,” Biomed. Sci. Instrum. 41: 193-198 (2005); Li, M., et al., “An Electrochemical Investigation of Hemoglobin and Catalase Incorporated in Collagen Films,” Biochm. Biophys. Acta 1749: 43-51 (2005); Karnicka, K., et al., “Polyoxometallates as Inorganic templates for Electrocatalytic Network Films of Ultra-Then Conducting Polymers and Platinum Nanoparticles, “Bioelectrochemistry 66: 79-87 (2005); Wu, M., et al., Fluorescence Imaging of the Activity of Glucose Oxidase Using a Hydrogen-Peroxide-Sensitive Europium Probe,” Anal. Biochem. 340: 66-73 (2005); Ren, C., et al., “Hydrogen Peroxide Sensor Based on Horseradish Peroxidase Immobilized on a Silver Nanoparticles/Cysteamine/Gold Electrode,” Anal. Bioanal. Chem. 381: 1179-1185 (2005); Lupetti, K. O., et al., “A Zucchini-Peroxidase Biosensor Applied to Dopamine Determination,” Farmaco. 60: 179-183 (2005); Tao, W., et al., “An Amperometric Hydrogen Peroxide Sensor Based on Immobilization of Hemoglobin in Poly(o-aminophenol) Film at Iron-Cobalt Hexacyanoferrate-Modified Gold Electrode,” Anal. Biochem. 338: 332-340 (2005); Li, C X., et al., “An Amperometric Hydrogen Peroxide Biosensor Based on Immobilizing Horseradish Peroxidase to a Nano-Au Monolayer Supported by Sol-Gel Derived Carbon Ceramic Electrode, “Bioelectrochemistry 65: 33-39 (2004); Albers, J., et al., “Electrical Biochip Technology—a Tool for Microarrays and Continuous Monitoring, “Anal. Bioanal. Chem. 377: 521-527 (2003); Ryan, O., et al., “Horseradish Peroxidase: The analyst's Friend,” Essays Biochem. 28: 129-146 (1994); Gorenek, G., et al., “Immobilization of Catalase by Entrapping in Alginate Beads and Catalase Biosensor Preparation for the Determination of Hydrogen Peroxide Decomposition,” Artif. Cells Blood Substit. Immobil Biotechnol. 32: 453-61 (2004); Yildiz H., et al., “Catalase Immobilization in Cellulose Acetate Beads and Determination of its Hydrogen Peroxide Decomposition Level by Using a Catalase Biosensor,” Artif. Cells Blood Substit. Immobil Biotechnol. 32: 443-452 (2004); Xu, Y., et al., “A New Film for the Fabrication of an Unmediated H₂O₂ Biosensor,” Biosens. Bioelectron. 20: 475-481 (2004); Li, C. X., et al., “Amperometric Hydrogen Peroxide Biosensor Based on Horesradish Peroxidase-Labeled Nano-Au Colloids Immobilized on Poly(2,6-pyridinedicarboxylic acid) Layer by Cysteamine,” Anal. Sci. 20: 1277-1281 (2004).

U.S. Pat. Nos. 6,503,701 & 6,322,963 issued to Bauer describe a passive biosensor detection system. While his system has similar features to the one described herewith, he does not suggest that oxygen generation by analyte-responsive catalytic degradation of hydrogen peroxide could be used for signal. Nowhere in his patents is hydrogen peroxide included in biosensor action. His obligatory detection units are not described as being designed for detecting bubbles, pO₂, or solution convection, as described for the present invention. Bauer specifically states that the system works in the mandatory presence of a detection unit, something that is not necessary in all embodiments of the present invention. Additionally, these patents do not describe nor fairly suggest analyte-responsive catalytic degradation of hydrogen peroxide. The same arguments may be put forth in regards to published U.S. patent application 20040037746 of common assignee.

While hundreds of sensors have been described in patents and in the scientific literature, actual commercial use of such sensors remains limited. In particular, virtually all sensor designs set forth in the prior art contain one or more inherent weaknesses. Some lack the sensitivity and/or speed of detection necessary to accomplish certain tasks. Other sensors lack long-term stability. Still others cannot be sufficiently miniaturized to be commercially viable or are prohibitively expensive to produce. Some sensors must be pre-treated with salts and/or enzyme cofactors, a practice that is inefficient and bothersome. To date, virtually all sensors are limited by the known methods of determining that contact has occurred between an immobilized binding agent and targeted analytes. Use of fluorescent or other external detection probes adds to sensor production requirements and reduces lifetimes of such sensor systems. Additionally, the inventor believes that there is no sensor method disclosed in the prior art that is generally applicable to the vast majority of macromolecular binding agents, including non-redox enzymes, antibodies, antigens, nucleic acids, receptors, and synthetic binding agents.

### SUMMARY OF THE INVENTION

It is therefore a primary object of some aspects of the present invention to provide an improved analyte detection system, in which a sensor strip composed of a base member and a binding agent layer is used in the detection of analyte-responsive enhanced catalytic degradation of hydrogen peroxide.

It is a further object of some aspects of the invention to describe an optical detection system for oxygen gas produced by said hydrogen peroxide degradation.

It is yet a further object of some aspects of the invention to describe a colorimetric detection system based on oxygen-sensitive reagents.

It is a still further object of some aspects of the invention to describe an a detection system for gas pressure, pO₂, or convection produced by said peroxide degradation

It is an additional object of some aspects of the invention to improve the consistency and ease of use in detection of an analyte in a sensor system by performing bio-sensing in an optically-clear disposable container.

In contrast to the above noted prior art, the practice of the present invention does not require application of an external voltage or electrical signal, enzyme-based oxidation-reduction chemistry, or presence of two electrodes in a single aqueous solution. Furthermore, in contrast to the above noted disclosures, the present invention does not rely on arrays or changes of applied electrical fields or signals as a function of analyte presence.

The methodology of analyte detection described herewith is very sensitive. Using the method of the present invention, it is possible to detect specific pathogenic bacteria consistently in a complex matrix within fifteen minutes at 1000 cells per milliliter of sample. In general, measurement of generated oxygen according to the present invention allows for simple, rapid, specific and sensitive determination of analyte presence. Methods for detecting analyte-related peroxide degradation include but are not limited to detecting changes in pH, increases in oxygen gas partial pressure or optical changes in base member surface appearance. In some embodiments, a detection unit may be employed to detect optical or other signals associated with analyte-responsive peroxide degradation. In other embodiments, changes in color or appearance of gas bubbles can be performed visually in the absence of any detection unit. These latter embodiments are particularly useful in low-technology settings as in the detection of malaria in third-world countries.

A sensor strip according to the invention may contain a plurality of identical or unique sensor strips so as to increase system detection redundancy and/or multiple analyte detection capabilities. Component binding agent layers of a composite sensor strip may be individually monitored, each component strip forming a part of a single sensor strip.

In preferred embodiments of the invention sensor strips are prepared from a portion of a container in which a biosensing experiment is performed. In such a case, binding agents specific for analyte are immobilized in proximity to the container in which sample of interest is added. Peroxide, generally hydrogen peroxide (H₂O₂), is added to sample prior to exposing sample to sensor strip in the container. Final H₂O₂ concentrations should be higher than 0.001% (volume to volume, v:v), but no higher than 10% v:v (though 35% has been successfully tested). Optimal H₂O₂ concentration is 0.1% v:v.

As analyte presence leads to generation of oxygen, several methods are available for detecting the generated oxygen, the amount of which is proportional to analyte in sample. In some cases, gas bubbles may be visualized directly on the container in which biosensing occurs. Alternatively, bubbles may be visualized directly on the sensor strip, when a sensor strip is separate from the container used in biosensing. Bubble detection may also be effected by the bubbles' effect on light shown either through the container or on the sensor strip (when a separate element) itself. In other embodiments, pO₂ or gas pressure may be measured as analyte-responsive oxygen is generated. Alternatively, oxygen-sensitive reagents may be employed; as analyte binds to sensor strip and oxygen is generated, the reagents change color to reveal analyte presence. Color changes may be identified directly or through use of a spectrophotometer or similar device. Alternatively, gas flow in the biosensing container can lead to solution convection, another indicator of analyte presence.

The invention provides a sensor for detecting an analyte, which minimally includes a base member, a binding agent layer associated with the base member and hydrogen peroxide. The base member and the binding agent layer minimally define a sensor strip, while additional layers such as a packaging layer over the binding agents may be included in the term “sensor strip” if they are physically associated with the base member.

An aspect of the sensor includes a chemical entity bound to the base member and disposed proximate the binding agent layer.

Yet another aspect of the sensor includes a container in which sensor strip, sample and hydrogen peroxide are contained during biosensing.

One aspect of the sensor includes a packaging layer disposed above the binding agent layer. The packaging layer is soluble in a medium that contains the analyte.

According to another aspect of the sensor, analyte presence is correlated to gas bubbles in said container. Said bubbles may be visually detected or may be identified by their perturbation of a light path through the container.

According to a further aspect of the sensor, analyte presence is correlated to increased pO₂ either in or immediately above said sample.

According to still a further aspect of the sensor, analyte presence is correlated to a change in color of an oxygen-sensitive reagent placed in said container

According to another aspect of the sensor, analyte presence is correlated to increased gas pressure or solution convection in said container.

According to another aspect of the sensor, the analyte is a plurality of analytes for detection.

In another aspect of the sensor, said base member may actually be a portion of said container, with binding agents bound either directly or through the agency of a chemical layer to said portion of said container.

In still another aspect of the sensor, an inhibitor to the enzyme catalase is added to the sample.

The invention provides a method for detecting a predetermined analyte, including the steps of providing a base member, and forming a binding agent layer of macromolecules in proximity to the base member surface, wherein the macromolecules are capable of interacting at a level of specificity with the predetermined analyte. The method further includes steps of adding hydrogen peroxide to said sample, exposing said sample with hydrogen peroxide to said sensor strip, and detecting analyte-responsive oxygen gas generation in said container.

One aspect of the method has the further step of binding a chemical entity to the base member and forming the binding agent layer proximate the chemical entity.

According to still a further aspect of the method, analyte detection is correlated to a change in color of an oxygen-sensitive reagent placed in said container

An aspect of the method includes detecting analyte through bubble formation in or on the container. Detection may involve visual observation or perturbation of light passed through said container.

An aspect of the method includes monitoring changes in light bounced off of the sensor strip as a function of bubble formation on said sensor strip.

In another aspect of the method, detecting analyte involves measuring analyte-responsive augmented pO₂ in or above the sample.

In another aspect of the method, detecting analyte involves measuring analyte-responsive augmented gas pressure in the closed container.

In another aspect of the method, detecting analyte involves measuring analyte-responsive solution convection in the sample.

In still another aspect of the method, multiple analytes are detected through the agency of a single or multiple sensor strips.

In a further aspect of the method, a portion of the container serves as the base member for binding agent layer formation.

According to an additional aspect of the method, an inhibitor for the enzyme catalase is added to sample prior to hydrogen peroxide addition.

One aspect of the method includes disposing a packaging layer above the binding agent layer. The packaging layer is soluble in a medium that contains the predetermined analyte.

According to another aspect of the method, the sensor strip includes a plurality of sensor strips.

According to another aspect of the method, the analyte is a plurality of analytes for detection.

### BRIEF DESCRIPTION OF THE DRAWINGS

For a better understanding of these and other objectives of the present invention, reference is made to the following detailed description of the invention, by way of example, which is to be read in conjunction with the following drawings, wherein:

FIG. 1 is a schematic view of a sensor detection system (100), which is constructed and operative in accordance with a preferred embodiment of the invention, wherein a sensor strip (122) comprised of base member (120), chemical entity (130), binding agent layer (140) and packaging layer (150) rests in sample (180) in clear plastic container (185);

FIG. 2 is a schematic of a sensor detection system (200) that is constructed and operative in accordance with an alternate embodiment of the invention. The sensor detection system (200) is similar to the sensor detection system (100) (FIG. 1), and like elements have like reference numerals, advanced by 100. In this sensor detection system (200), a portion of a clear plastic container (285) serves as the base member (220) on which binding agent layer (240) is constructed.

FIG. 3 is a schematic of a sensor detection system (300) that is constructed and operative in accordance with an alternate embodiment of the invention. The sensor detection system (300) is similar to the sensor detection system (100) (FIG. 1), and like elements have like reference numerals, advanced by 200. In this sensor detection system (300), the disposable plastic container (385) is closed and gas pressure is measured through pressure gauge (395).

FIG. 4 is a schematic of a sensor detection system (400) that is constructed and operative in accordance with an alternate embodiment of the invention. The sensor detection system (400) is similar to the sensor detection system (100) (FIG. 1), and like elements have like reference numerals, advanced by 300. In this sensor detection system (400), a pO₂ electrode (496) is placed in sample (480).

FIG. 5 is a schematic of a sensor detection system (500) that is constructed and operative in accordance with an alternate embodiment of the invention. The sensor detection system (500) is similar to the sensor detection system (100) (FIG. 1), and like elements have like reference numerals, advanced by 400. In this sensor detection system (500), base member (520) is a silicon chip and the disposable plastic container (585) is closed.

FIG. 6 is a schematic of a sensor detection system (600) that is constructed and operative in accordance with an alternate embodiment of the invention. The sensor detection system (600) is similar to the sensor detection system (100) (FIG. 1), and like elements have like reference numerals, advanced by 500. In this sensor detection system (500), a light source (697) and light detector (698) are used for the detection of bubbles (699) in solution.

FIG. 7 is a schematic of a sensor detection system (700) that is constructed and operative in accordance with an alternate embodiment of the invention. The sensor detection system (700) is similar to the sensor detection system (600) (FIG. 6), and like elements have like reference numerals, advanced by 100. In this sensor detection system (700), a light source (797) and light detector (798) are used for the detection of bubbles (799) on sensor strip (522) base member (520).

FIG. 8 is a photograph of an experiment performed with sensor strips corresponding to sensor detection system 100 (FIG. 1) in which sensor strips were used for the unique detection of a specific bacterial target.

FIG. 9 is a photograph of an experiment performed with sensor strips corresponding to sensor detection system 500 (FIG. 5) in which sensor strips were used for the unique detection of a specific bacterial target.

FIG. 10 is a photograph of an experiment performed with sensor strips corresponding to sensor detection system 200 (FIG. 2) in which sensor strips were used for the unique detection of a specific bacterial target.

FIG. 11 is a schematic diagram of the proposed mechanism of action of the present biosensor invention.

FIG. 12 is a photograph of an experiment performed with silicon chip based sensor strips in absence of a container.

### DESCRIPTION OF THE PREFERRED EMBODIMENT

In the following description, numerous specific details are set forth in order to provide a thorough understanding of the present invention. It will be apparent, however, to one skilled in the art that the present invention may be practiced without these specific details. In other instances well-known circuits and control logic have not been shown in detail in order not to unnecessarily obscure the present invention.

### Definitions

Certain terms are now defined in order to facilitate better understanding of the present invention.

An “analyte” is a material that is the subject of detection or quantification.

A “base member” is a solid element on which binding agents are immobilized. The term “base member” refers to any solid material on which binding agents are physically immobilized, whether said solid material be electrically insulating conducting, or semiconducting

“Macromolecules”, “macromolecular binding agents”, “binding agents” or “macromolecular entities” can be any natural, mutated, synthetic, or semi-synthetic molecules that are capable of interacting with a predetermined analyte or group of analytes at a level of specificity.

A “binding agent layer” is a layer composed of one or a plurality of binding agents. The binding agent layer may be composed of more than one type of binding agent. A binding agent layer may additionally include molecules other than binding agents. Cross-linking agents may be applied to bind separate components of a binding agent layer together.

A “chemical entity” is a chemical layer that is disposed proximate a base member either one or both sides of the base member. The chemical entity rests between the base member and the binding agent layer. The chemical entity serves to immobilize binding agents proximate base member. Chemical entities may be differentially deposited on opposite sides of a base member surface by any means or multiple layers on a given side of the base member may be considered a single chemical entity.

A “packaging layer” is defined as a chemical layer disposed above the binding agent layer. The packaging layer may aid in long term stability of the macromolecules, and in the presence of a sample that may contain analyte of interest, the packaging layer may dissolve to allow for rapid interaction of analyte and binding agents. The packaging layer may also serve in conjunction with the charged macromolecules in the role of a semiconductive element defined below. Such may be the case when a sensor is coated equally on both sides with chemical entities, macromolecules, and packaging layer.

A “sensor strip” is defined as a minimum of a single base member and its associated binding agent layer. The base member surface and any macromolecular entities, chemical entities, packaging layers or other elements physically associated with the base member are included in the term “sensor strip”.

A “peroxide” refers to any material of structure R—O—O—R′. In hydrogen peroxide, R═R′=hydrogen. The expression “peroxide” refers to hydrogen peroxide and other members of this class of chemicals.

pO₂ has its normal meaning and refers to the partial pressure of oxygen associated with a solution.

“Degradation” with reference to hydrogen peroxide specifically refers to the breakdown of hydrogen peroxide to water and oxygen gas. There is no enzymatic breakdown of hydrogen peroxide in the present invention and there is no transfer of electrons between the sensor strip, its components and hydrogen peroxide.

“Catalase inhibitor” refers to a chemical that inhibits the enzyme catalase and thus prevents its catalytic degradation of hydrogen peroxide to oxygen and water.

“Oxygen-sensitive reagent” is any chemical or material that changes color or other noticeable property as a result of the interaction of said chemical or material with oxygen.

Without being bound by any particular theory, the following discussion is offered to facilitate understanding of the invention. The sensor design disclosed herein is based on analyte-responsive enhanced catalytic degradation of a hydrogen peroxide in an aqueous solution. The sensor utilizes a novel method of detecting an analyte wherein macromolecular binding agents are first immobilized as a binding agent layer proximate a solid base member. Base member may be any solid material, independent of electrical properties. Binding of analyte causes a marked increase in the catalytic non-enzymatic degradation of hydrogen peroxide, with concomitant increase in dissolved oxygen. In the present invention, the advantages of particular forms of sensor strip embodiments are disclosed. Specifically, a sensor strip may be a separate element of base member and binding agents or alternatively may be formed directly as part of a container in which a biosensing experiment according to the present invention is performed.

In the various embodiments disclosed herein, like elements have like reference numerals differing by multiples of 100.

### First Embodiment

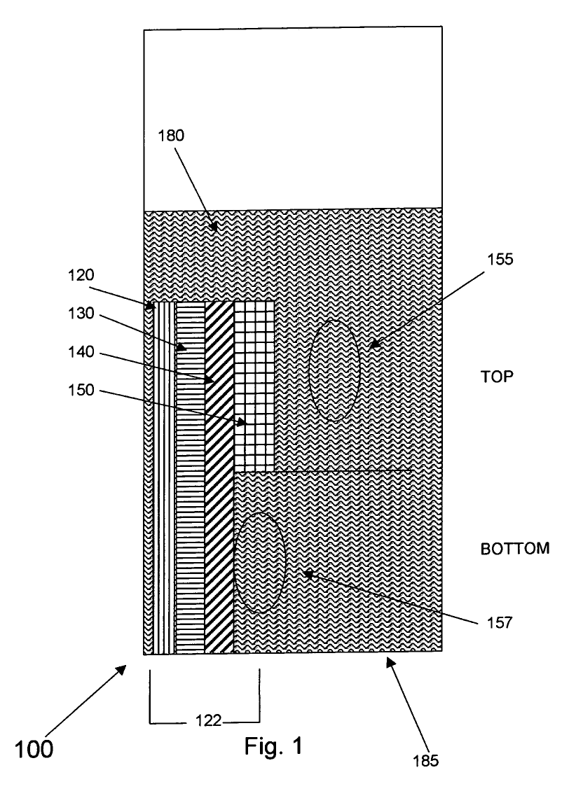

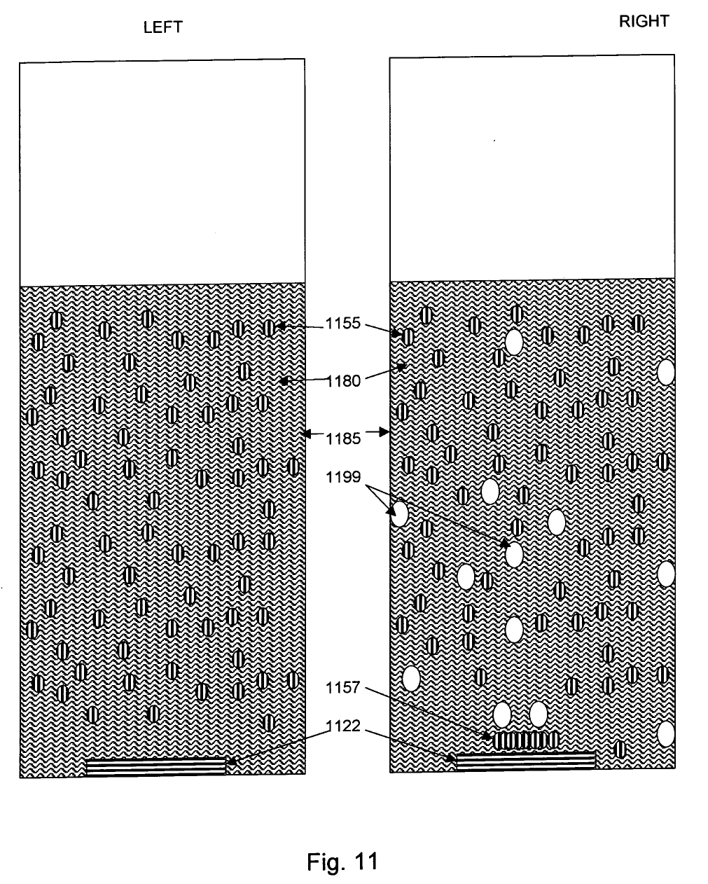

Reference is now made to FIG. 1, which is a schematic of a sensor detection system (100) that is constructed and operative in accordance with a preferred embodiment of the invention. Container (185) holds sample (180) that contains unbound analyte (TOP, 155) and buffered hydrogen peroxide, H₂O₂ (not shown) at a concentration of greater than 0.001% (volume:volume) but not in excess of 10% (volume:volume). A sensor strip (122) composed of solid base member (120), chemical entity (130), binding agent layer (140) and packaging layer (150) is present in the container (185) when sample (180) is added. The packaging layer (150) dissolves (BOTTOM, FIG. 1) to allow for binding of analyte (157, bound analyte). Bound analyte (157) leads to increased charge concentration (1199, FIG. 11) that catalyzes increased degradation of hydrogen peroxide to water and oxygen. Oxygen may be detected by several means, as discussed previously.

The packaging layer (150), shown on the TOP of FIG. 1, is a layer of water-soluble chemicals deposited above the immobilized macromolecules of the binding agent layer (140). The packaging layer (150) may be deposited by soaking or spraying methods. The packaging layer (150) serves to stabilize the binding agent layer (140) during prolonged dry storage. In the absence of a packaging layer, oil and dirt may build up on the hydrophilic binding agent layer (140) and may interfere with the rapid action of the sensor system. A commercial solution, StabilGuard (Surmodics, Inc., 9924 West 74^{th} Street, Eden Prairie, Minn., 55344, USA) is typically used for the packaging layer (150) so as to guarantee packaging layer dissolution in aqueous samples, and thus facilitate direct interaction between macromolecular binding agents of binding agent layer (140) and analytes (157). Other chemicals may be chosen for use in the packaging layer. Water-soluble polymers, sugars, salts, organic, and inorganic compounds are all appropriate for use in preparation of the packaging layer (150).

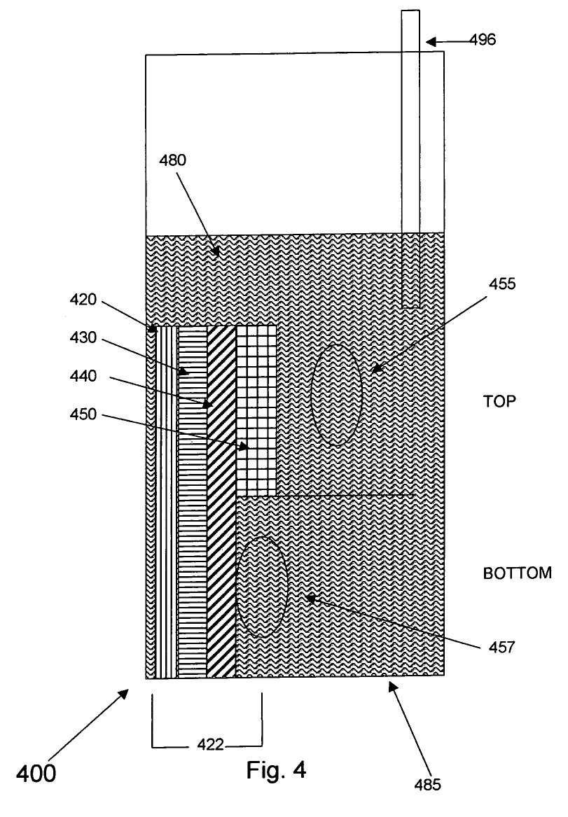

As shown on the TOP of FIG. 1, free analyte (155) is disposed proximate the packaging layer (150) prior to the latter's dissolution. When the packaging layer (150) dissolves, the macromolecules incorporated in the binding agent layer (140) are free to immediately interact with analyte (157), as shown on the BOTTOM of FIG. 1. After dissolution of the packaging layer (150), analyte (157) is shown interacting with the binding agent layer (140) on the BOTTOM of FIG. 1. The analyte (155, 157) can be a member of any of the following categories, listed herein without limitation: cells, organic compounds, antibodies, antigens, virus particles, pathogenic bacteria, toxins, metals, metal complexes, ions, spores, yeasts, molds, cellular metabolites, enzyme inhibitors, receptor ligands, nerve agents, peptides, proteins, fatty acids, steroids, hormones, narcotic agents, synthetic molecules, medications, enzymes, nucleic acid single-stranded or double-stranded polymers. The analyte (155) can be present in a solid, liquid, gas or aerosol. The analyte (155) could even be a group of different analytes, that is, a collection of distinct molecules, macromolecules, ions, organic compounds, viruses, toxins, spores, cells or the like that are the subject of detection or quantification. Some of the analyte (157) physically interacts with the sensor strip (122) after dissolution of the packaging layer (150) and causes an increase in catalytic degradation of hydrogen peroxide to water and oxygen gas. There is no requirement for application of a voltage or other electrical signal to the sensor strip (122) prior to or during biosensing and in most embodiments there is no requirement for electrode whatsoever. In some embodiments, a single oxygen electrode may be employed (FIG. 4) for measurement of pO₂.

Examples of macromolecular binding agents suitable for use as the binding agent layer (140) include, but are not limited to enzymes that recognize substrates and inhibitors, antibodies that bind antigens, antigens that recognize target antibodies, receptors that bind ligands, ligands that bind receptors, nucleic acid single-strand polymers that can bind to form DNA-DNA, RNA-RNA, or DNA-RNA double strands, and synthetic molecules that interact with targeted analytes. The present invention can thus make use of non-redox enzymes, peptides, proteins, antibodies, antigens, catalytic antibodies, fatty acids, receptors, receptor ligands, nucleic acid strands, as well as synthetic macromolecules as the binding agents in the binding agent layer (140). Natural, synthetic, semi-synthetic, over-expressed and genetically-altered macromolecules may be employed as binding agents. The binding agent layer (140) may form monolayers, multilayers or mixed layers of several distinct binding agents or binding agents with other chemical components (not shown). A monolayer of mixed binding agents may also be employed (not shown). The binding agents in the binding agent layer (140) may be cross-linked together with glutaraldehyde or other chemical cross-linking agents.

The macromolecule component of the binding agent layer (140) is neither limited in type nor number. Non-redox enzymes, peptides, receptors, receptor ligands, antibodies, catalytic antibodies, antigens, cells, fatty acids, synthetic molecules, and nucleic acids are possible macromolecular binding agents in the present invention. The sensor detection system (100) may be applied to detection of many classes of analyte because it relies on the following properties shared by substantially all applications and embodiments of the sensor detection system according to the present invention:

(1) that the macromolecules chosen as binding agents are highly specific entities designed to bind only with a selected analyte or group of analytes;

(2) that analytes may interact at a level of specificity with the macromolecules;

(3) that binding of analyte increases the electrostatic catalytic degradation of hydrogen peroxide by concentrating positive electrostatic potential on the sensor strip (FIG. 11, right); and

(4) that said analyte-responsive hydrogen peroxide degradation leads to oxygen gas generation, with oxygen gas being detected as gas bubbles, increased pO₂, solution convection, increased gas pressure, change in color of oxygen-sensitive reagents or through other oxygen detection phenomena.

The broad and generally applicable function of the sensor detection system (100) is preserved during formation of the binding agent layer (140) in proximity to the base member (120) because the binding agent layer (140) formation can be effected by either specific covalent attachment or general physical absorption. A chemical entity (130), such as a self-assembled monolayer, may be used in the physical absorption of the binding agent layer (140) proximate the base member (120). It is to be emphasized that the catalytic degradation of hydrogen peroxide that is associated with analyte presence does not depend on any specific enzyme chemistries, optical effects, fluorescence, chemiluminescence or applied electrical signals. These features are important advantages of the present invention.

### Second Embodiment

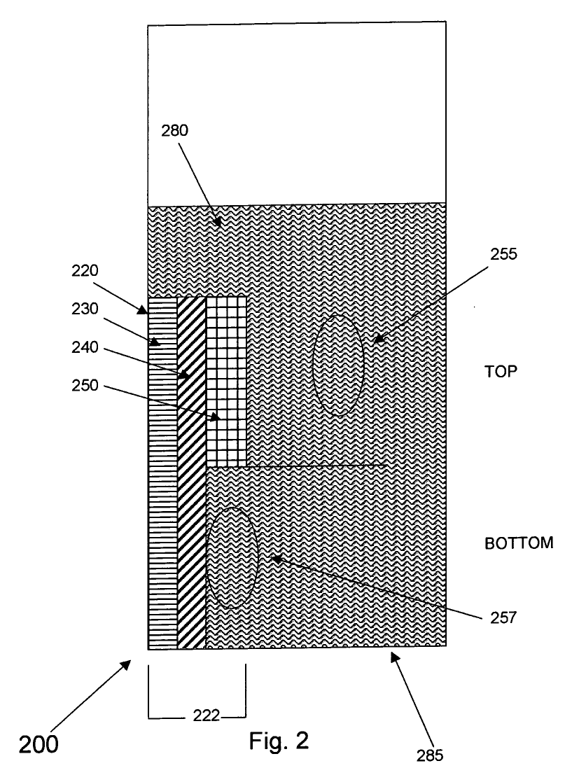

Reference is now made to FIG. 2, which is a schematic of a an alternative embodiment of a sensor detection system (200) that is constructed and operative in accordance with a preferred embodiment of the invention. Container (285) holds sample (280) that contains un-bound analyte (TOP, 255) and buffered hydrogen peroxide, H₂O₂ (not shown) at a concentration of greater than 0.0001% (volume:volume) but not in excess of 10% (volume:volume). A sensor strip (222) composed a base member (220) made from a portion of the container (285), optional chemical entity (230), binding agent layer (240) and packaging layer (250) is present in the container (285) when sample (280) is added. The packaging layer (250) dissolves (BOTTOM, FIG. 2) to allow for binding of analyte (257, bound analyte). Bound analyte (257) leads to increased charge concentration (FIG. 11, right) that catalyzes increased degradation of hydrogen peroxide to water and oxygen gas (1199, FIG. 11. Oxygen may be detected by several means, as discussed previously.

### Third Embodiment

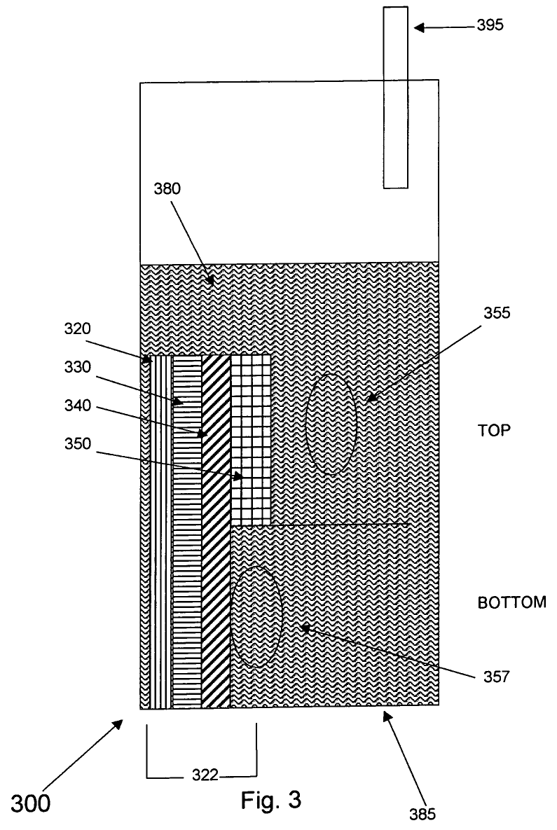

Reference is now made to FIG. 3, which is a schematic of an alternative embodiment of a sensor detection system (300) that is constructed and operative in accordance with a preferred embodiment of the invention. Container (385) holds sample (380) that contains un-bound analyte (TOP, 355) and buffered hydrogen peroxide, H₂O₂ (not shown) at a concentration of greater than 0.001% (volume:volume) but not in excess of 10% (volume:volume). A sensor strip (322) composed of solid base member (320), chemical entity (330), binding agent layer (340) and packaging layer (350) is present in the container (385) when sample (380) is added. The packaging layer (350) dissolves (BOTTOM, FIG. 3) to allow for binding of analyte (357, bound analyte). Bound analyte (357) leads to increased charge concentration (FIG. 11, right) that catalyzes increased degradation of hydrogen peroxide to water and oxygen. Oxygen is detected by gas pressure sensor (395) in closed container (385) as an increase in gas pressure over sample (380).

### Fourth Embodiment

Reference is now made to FIG. 4, which is a schematic of an alternative embodiment of a sensor detection system (400) that is constructed and operative in accordance with a preferred embodiment of the invention. Container (485) holds sample (480) that contains un-bound analyte (TOP, 455) and buffered hydrogen peroxide, H₂O₂ (not shown) at a concentration of greater than 0.001% (volume:volume) but not in excess of 10% (volume:volume). A sensor strip (422) composed of solid base member (420), chemical entity (430), binding agent layer (440) and packaging layer is present in the container (485) when sample (480) is added. The packaging layer (450) dissolves (BOTTOM, FIG. 4) to allow for binding of analyte (457, bound analyte). Bound analyte (457) leads to increased charge concentration (FIG. 11, right) that catalyzes increased degradation of hydrogen peroxide to water and oxygen. Oxygen is detected by pO₂ electrode (496). The oxygen electrode (496) may be in sample (480) as shown in FIG. 4 or it may alternatively measure pO₂ in the vapor (491) immediately above sample (480) (not shown). Increase in pO₂ signals analyte presence and its interaction with bound binding agent layer (440).

### Fifth Embodiment

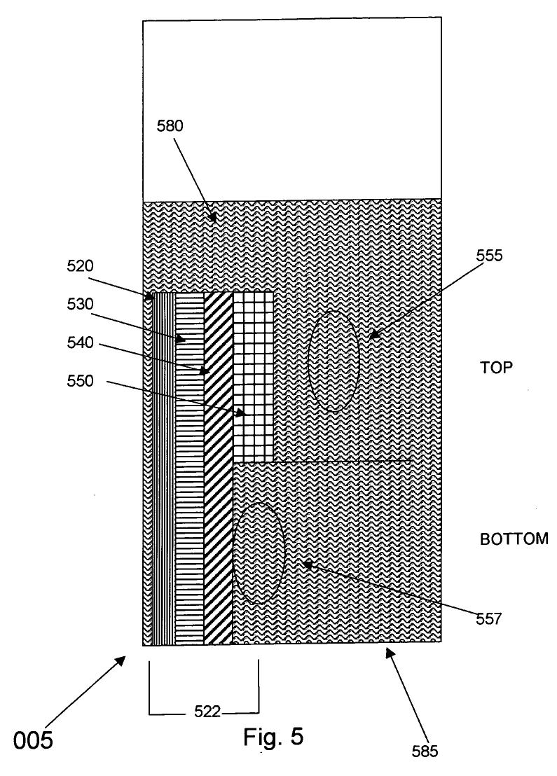

Reference is now made to FIG. 5, which is a schematic of an alternative embodiment of a sensor detection system (500) that is constructed and operative in accordance with a preferred embodiment of the invention. Container (585) holds sample (580) that contains un-bound analyte (TOP, 555) and buffered hydrogen peroxide, H₂O₂ (not shown) at a concentration of greater than 0.001% (volume:volume) but not in excess of 10% (volume:volume). A sensor strip (522) composed of wafer silicon (520), optional chemical entity (530), binding agent layer (540) and packaging layer is present in the container (585) when sample (580) is added. The packaging layer (550) dissolves (BOTTOM, FIG. 5) to allow for binding of analyte (557, bound analyte). Bound analyte (557) leads to increased charge concentration (FIG. 11, right) that catalyzes increased degradation of hydrogen peroxide to water and oxygen. Oxygen is detected by one of several means as previously described.

### Sixth Embodiment

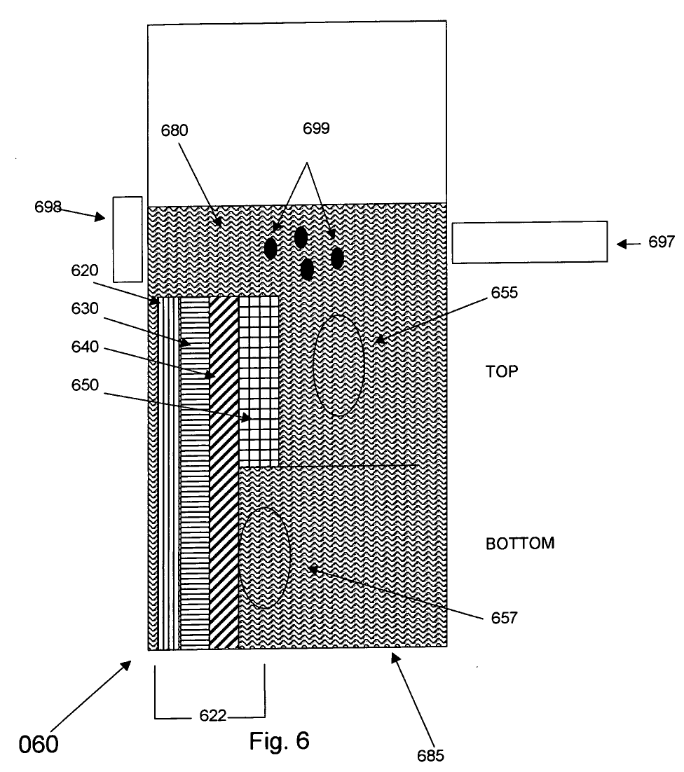

Reference is now made to FIG. 6, which is a schematic of an alternative embodiment of a sensor detection system (600) that is constructed and operative in accordance with a preferred embodiment of the invention. Optically clear container (685) holds sample (680) that contains un-bound analyte (TOP, 655) and buffered hydrogen peroxide, H₂O₂ (not shown) at a concentration of greater than 0.001% (volume:volume) but not in excess of 10% (volume:volume). A sensor strip (622) composed of solid base member (620), chemical entity (630), binding agent layer (640) and packaging layer is present in the container (685) when sample (680) is added. The packaging layer (650) dissolves (BOTTOM, FIG. 6) to allow for binding of analyte (657, bound analyte). Bound analyte (657) leads to increased charge concentration (FIG. 11, right) that catalyzes increased degradation of hydrogen peroxide to water and oxygen. Oxygen is detected by the interference of gas bubbles (699) as detected by the change in optical properties of light propagated from a light source (697) to a light detector (698).

### Seventh Embodiment

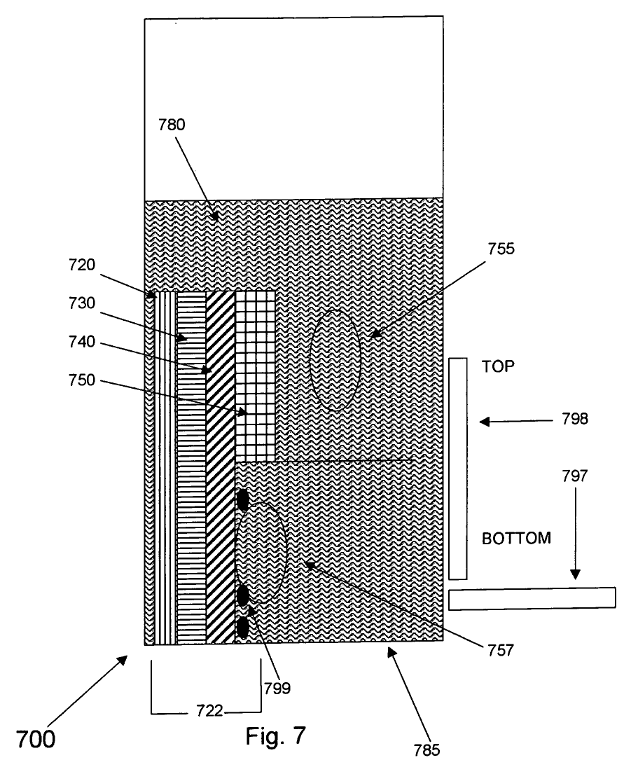

Reference is now made to FIG. 7, which is a schematic of an alternative embodiment of a sensor detection system (700) that is constructed and operative in accordance with a preferred embodiment of the invention. Optically clear container (785) holds sample (780) that contains un-bound analyte (TOP, 755) and buffered hydrogen peroxide, H₂O₂ (not shown) at a concentration of greater than 0.001% (volume:volume) but not in excess of 10% (volume:volume). A sensor strip (722) composed of solid base member (720), chemical entity (730), binding agent layer (740) and packaging layer is present in the container (785) when sample (780) is added. The packaging layer (750) dissolves (BOTTOM, FIG. 7) to allow for binding of analyte (757, bound analyte). Bound analyte (757) leads to increased charge concentration (FIG. 11, right) that catalyzes increased degradation of hydrogen peroxide to water and oxygen. Oxygen is detected by the interference of gas bubbles (799) as detected by the change in optical properties of light propagated from a light source (797), reflected off the sensor strip (722) base member (720) and measured in a light detector (798) as shown in FIG. 7.

### EXAMPLE 1

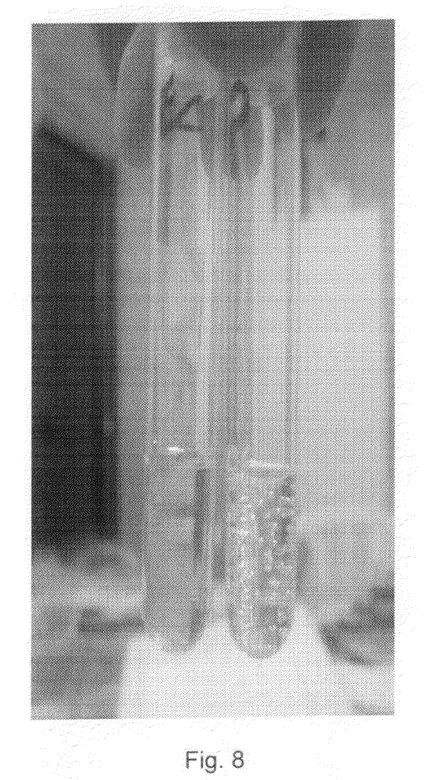

The analysis in this example was performed using the embodiment of FIG. 1. Testing for Pseudomonas aeruginosa was performed in phosphate buffer solution, pH 7.15. Aluminum foil having a matte surface and a shiny surface (Extra Heavy-Duty Diamond Foil, Reynolds Metals Co., 555 Guthridge Court, Norcross, Ga. 30092) was cut into 6 centimeter by 8 centimeter pieces and soaked in an ethanolic (Carmel Mizrahi, Rishon Letzion, Israel, 95%) solution of docosanoic acid (21,694-1, Aldrich Chemical Company, Milwaukee, Wis.) for 20 minutes and then rinsed with distilled water. The soakings were performed in 100 milliliter piranha-treated (70% sulfuric acid; 30% hydrogen peroxide) beakers, with the self-assembled monolayer (SAM) surfactant solution standing at 20 milliliters in the beaker. Hydrophobic SAM-coated foil pieces were next transferred to 20 milliliters of aqueous phosphate-buffered solutions (pH 7.2) of polyclonal antibodies specific for P. aeruginosa antigen (Product B47578P, Biodesign International, 60 Industrial Park Road, Saco, Me. 04072 USA) at an approximate concentration of 18 microgram per milliliter. The solution was kept in contact with the SAM-coated aluminum foil for approximately 20 minutes and then the coated aluminum foil was rinsed with phosphate buffer lacking antibody. The hydrophilic coated aluminum foil was next soaked for 3 minutes in 20 milliliters of StabilGuard (SG01-0125, Surmodics, 9924West 74^{th} Street, Eden Prairie, Minn. 55344). After coating, the coated foil was dried at 37 degrees Celsius for approximately one hour, after which it was transferred to a sealed bag that contained calcium sulfate drying agent (238988-454G, “Drierite”, Aldrich Chemical Company). Prior to use, the coated foil was removed from its storage bag. 1 cm×10 cm rectangles of coated sensor strip (122) were cut and placed in plastic test tubes. Samples were prepared from phosphate buffer (8 mM) that contained hydrogen peroxide at 0.1% (v:v). One sample contained Pseudomonas aeruginosa cells at an approximate concentration of 10⁴ cells per milliliter, while the other sample contained E. coli at a similar concentration. The samples (180) were added to the container (185) containing the coated sensor strip (122) composed of aluminum base member (120), SAM chemical entity (130), a binding agent layer (140) composed of polyclonal antibodies and StabilGuard packaging layer (150). As shown in FIG. 8, the sample with Pseudomonas aeruginosa (right tube) showed significant oxygen gas generation, while the sample that contained the non-target E. coli (left tube) showed no appreciable bubbling.

### EXAMPLE 2

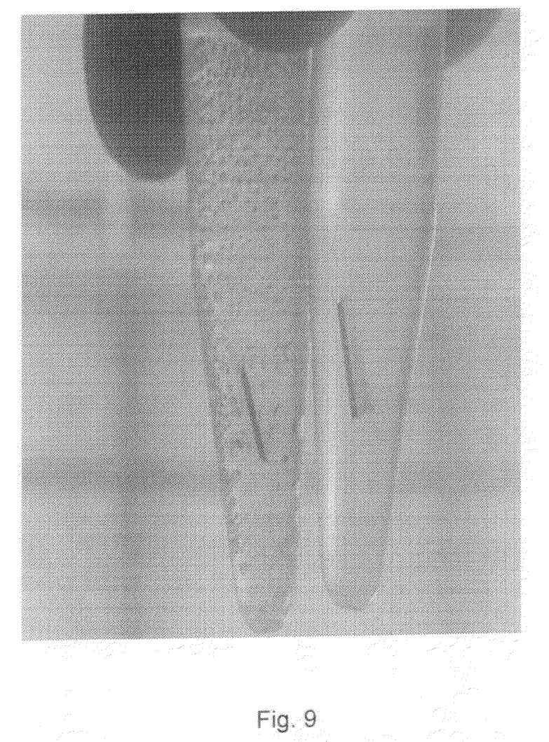

The analysis in this example was performed using the embodiment of FIG. 5. N-type silicon (Silicon Sense, N.H., USA) was cut into 1×1 cm² pieces and rinsed in 95% ethanol (Carmel Mizrahi, Israel). The chips were then rinsed in DI water and placed in piranha solution. After piranha cleaning for 30 minutes at 80 degrees Celsius, the chips were rinsed in copious amounts of DI water, and then transferred to a 20 milliliter solution of ammonium fluoride (Aldrich product number 338869; 40% weight:volume in DI water). When the chips appeared hydrophobic due to the generation of silicon hydride on the chip surfaces, the chips were transferred to a phosphate-buffered solution of Pseudomonas-specific polyclonal antibodies (Biodesign, Product B47578P) mixed in a 1:100 ratio with bovine serum albumin (BSA, Sigma Chemical Co.). The chips readily became hydrophilic as phosphate and then protein bound to the surface. The chips were next transferred to StabilGuard for packaging layer formation and then allowed to dry at 37 degrees Celsius. In this example, silicon acts as base member (520), phosphate serves as chemical entity (530), polyclonal antibodies with BSA form the binding agent layer (540), while StabilGuard is the packaging layer (550). Dried chips were transferred to samples (580) in Eppendorf tube containers (585) that contained either sample (580) with either Pseudomonas aeruginosa cells (FIG. 9, left side) or E. coli (FIG. 9, right side) in addition to dilute amounts of hydrogen peroxide. As is clear from the samples shown in FIG. 9, the sample with Pseudomonas analyte (555, 557) shows much greater gas bubble formation than does the sample that lacks analyte recognized by the binding agent layer (540).

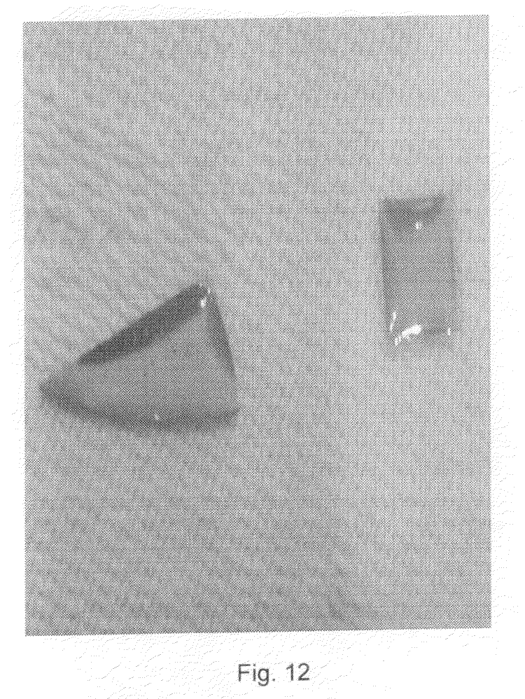

FIG. 12 shows results of a parallel experiment performed in absence of a container. The coated silicon chips were each exposed to 30 microliters of either Pseudomonas or E. coli solutions that contained hydrogen peroxide at 0.1% v:v. Only the chip exposed to Pseudomonas (left side of FIG. 12) showed gas bubbles related to analyte-responsive increased oxygen concentration, while the chip exposed to E. coli (right side of FIG. 12) showed no response.

### EXAMPLE 3

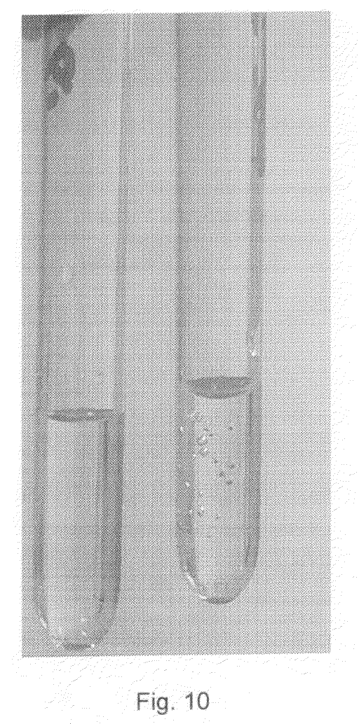

The analysis in this example was performed using the embodiment of FIG. 2. Plastic test tubes (Sarstedt, Germany, 5 mL size) were soaked in a phosphate solution of polyclonal antibodies specific for Pseudomonas aeruginosa. (Biodesign B47578P). The solution was later removed and the tubes were used immediately. Pseudomonas or E. coli was added in a phosphate-buffered solution with hydrogen peroxide at 0.1% v:v. In FIG. 10, the Pseudomonas sample shows bubbling on the right side of the figure due to the analyte-responsive hydrogen peroxide degradation (there are no bubbles in absence of hydrogen peroxide). E. coli, lacking specificity of the binding agent layer (240) does not lead to charge concentration (FIG. 11) and thus there is no apparent bubbling in the E. coli sample on the left side of FIG. 10.

### SUMMARY

FIG. 11 summarizes the theory behind the present invention. Sensor strip (1122) sits in sample (1180) in a container (1185). Free analyte (1155) can bind with binding agents of the sensor strip (1122) and thus concentrate the charge in the sample (1180) from its uniform distribution (left side, FIG. 11). This charge concentration associated with bound analyte (1157) seen on sensor strip (1122, right side, FIG. 11) leads to augmented catalytic degradation of hydrogen peroxide to water and oxygen gas (1199). The oxygen gas (1199) can be detected as presence of bubbles, increased pO₂ or container gas pressure, changes in color of oxygen-sensitive reagents or by other oxygen-related detection means

The implications of the invention described herein are that nearly any material that can be recognized at a level of specificity by a peptide, protein, antibody, non-redox enzyme, receptor, nucleic acid single strand, synthetic binding agent, or the like can be detected and quantified safely in food, body fluids, air or other samples quickly, cheaply, and with high sensitivity. Response is very rapid, generally less than 10 minutes. Cost of manufacture is low, and sensitivity has been shown to be very good.

The present invention has been described with a certain degree of particularity, however those versed in the art will readily appreciate that various modifications and alterations may be carried out without departing from the spirit and scope of the following claims. Therefore, the embodiments and examples described here are in no means intended to limit the scope or spirit of the methodology and associated devices related to the present invention. Sample may be presented to the sensor strip by static or flow means, including but not limited to microfluidic delivery of sample to sensor strip.

1. A biosensor for detecting or quantifying of an analyte in a sample, comprising: a base member; a binding agent layer, wherein said binding agent layer and said base member define a sensor strip, macromolecules of said binding agent layer being interactive at a level of specificity with a predetermined analyte; and, a gas bubble detector.

2. The sensor according to claim 1, further comprising a chemical entity disposed between said base member and said binding agent layer.

3. The sensor according to claim 1 further comprising a container in which sample and sensor strip are placed.

4. The sensor according to claim 1, further comprising a light source in said bubble detector.

5. The sensor according to claim 1, further comprising an optical detection component of said bubble detector.

6. The sensor according to claim 1, wherein said analyte represents a plurality of unique analytes.

7. The sensor according to claim 1, wherein said base member is physically associated with the container in which sample is placed.

8. The sensor according to claim 1, wherein sensor strip is exposed to hydrogen peroxide during or after sensor strip exposure to sample.

9. A method for detecting a predetermined analyte in a sample, comprising the steps of:
providing a solid base member;
forming a binding agent layer of macromolecules in proximity to said base member, said binding agent layer and said base member defining a sensor strip, wherein said macromolecules are capable of interacting at a level of specificity with said predetermined analyte;
exposing sensor strip to sample; and,
detecting gas bubbles in said container.

10. The method according to claim 9, further comprising the steps of:
binding a chemical entity to a base member surface; and
forming said binding agent layer proximate said chemical entity.

11. The method according to claim 9, further comprising the step of
exposing sensor strip to hydrogen peroxide at a final concentration of 0.3% volume to volume.

12. The method according to claim 9, wherein said gas bubbles are detected visually in said container or on said sensor strip.

13. The method according to claim 9, wherein said gas bubbles are detected through their perturbation of light directed by a gas bubble detector at said container.

14. The method according to claim 9, wherein said gas bubbles are detected by light scattered by said gas bubbles in said container.

15. The method according to claim 9, wherein the base member is a portion of the container into which sample is added.

16. The method according to claim 9, wherein said gas bubbles are detected by means of their perturbation of light transmission through the container.

17. The method according to claim 9, wherein said gas bubbles are detected by their appearance in an optical image of sample taken by a gas bubble detector.

18. The method according to claim 9, wherein said analyte represents a plurality of unique analytes.

19. The method according to claim 9, wherein said sensor strip represents a plurality of sensor strips.

20. An electrode-free biosensor for detection or quantification of an analyte in a sample, comprising:
a base member;
a binding agent layer, wherein said binding agent layer and said base member define a sensor strip, macromolecules of said binding agent layer being interactive at a level of specificity with a predetermined analyte; and,
hydrogen peroxide in fluid contact with said sensor strip.
